(19) United States
(12) Patent Application Publication
(10) Pub. No.: US 2002/0170184 A1
(43) Pub. Date: Nov. 21, 2002

(54) Control system for a handheld tool

(76) Inventor: Arlan Duane Lothe, Adams, WI (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/946,896

(22) Filed: Sep. 4, 2001

(51) Int. Cl. B26B 29/00

(52) U.S. Cl. 30/295; 30/296.1; 30/298

(57) ABSTRACT

A control system is provided for improving the maneuverability of a handheld tool such as a knife. The apparatus of the present invention includes a control knob disposed upon the shaft or blade and spaced apart from the handle to create a finger gap. The methods of the present invention include grasping the control knob and/or grasping the finger gap while loosely cradling the tool handle. Another method includes grasping the handle and extending one or more digits of the hand beyond the hilt to grasp the control knob and/or the finger gap, while maintaining a grip on the handle. The control knob and the finger gap work together with the tool handle and the user's hand to provide improved maneuverability of the handheld tool.

### TECHNICAL FIELD

The present invention relates generally to the field of handheld tools and, more particularly, to a system and apparatus for improving the maneuverability of a handheld tool such as a knife.

### BACKGROUND OF THE INVENTION

The safe and effective use of handheld tools such as knives requires a firm grip and precise control. The ability to control the motion of a tool has a direct effect upon its safety and usefulness. Control and precision are especially important when using a knife or other sharp tool in an environment where a risk of injury is present.

Handle designs for tools have evolved over the years to provide the user with improved control. Features such as finger grips and curved handle shapes have improved the grip of various tools and utility knives. Many knives, for example, include a bolster or guard at the end of the handle, next to the blade, to prevent the hand from slipping onto the blade during use. Other knife designs include a small platform on the top of the bolster that enables the user to apply a greater downward cutting force. Such bolster platforms, however, only assist the user when pressing the knife in the downward direction.

Advanced cutting techniques, too, have evolved to improve the utility and safety of knives and tools. Carpenters sometimes use a second hand to guide or stabilize the turning shaft of a screwdriver. Chefs sometimes pinch the back edge of a knife blade when chopping or dicing foods. Many tasks in the culinary arts and other endeavors require precise control of a handheld tool. These manual methods, however, provide only limited guidance to a user who needs to accomplish a delicate task or make a precise cut.

There is an unsatisfied need in the art for greater safety and greater control than is provided by handle shapes, special bolsters, or manual techniques. Precision tasks, to be done safely, require a handheld tool that facilitates a positive grip, clear visibility of the workpiece, significant leverage, and greater control in all directions. None of the handle designs or other devices in the art currently meet these needs.

Thus, there is a need for a control system for a handheld tool that provides a positive grip for safety, improved visibility of the workpiece, greater leverage for cutting power, and precise control in all directions. Such a control system would be useful for a variety of devices and handheld tools including utility and culinary knives.

### SUMMARY OF THE INVENTION

The above and other needs are met by the present invention which, stated generally, seeks to provide a control system for improving the maneuverability of a handheld tool such as a knife. Improved control and maneuverability is accomplished according to the present invention in a handheld tool, comprising a control knob disposed upon the shaft and spaced apart from the handle to create a finger gap. The finger gap is long enough to receive one or more digits of a hand. In one embodiment, the length of the finger gap may be adjusted. The control knob and the finger gap work together with the user's hand to provide improved maneuverability of the tool.

In one preferred embodiment, the control knob is ovoid or egg-shaped, although other graspable shapes may be used. The control knob is sized to be easily grasped and, preferably, has a textured surface. For certain applications, the control knob may be made of a soft, pliable material that can be pinched. In one embodiment, the position of the control knob may be adjusted.

In one embodiment where the handheld tool is a knife, the shaft of the tool is a knife shank having opposing tang and blade ends. The tang end is inserted or otherwise connected to the handle and the blade end extends lengthwise from the distal end of the handle. In this embodiment, the implement is a knife blade that has a cutting edge and a back edge. The control knob is positioned along the back edge of the blade and spaced apart from the handle, thereby creating a finger gap for use with the knife.

In another aspect of the invention, the handle and control knob, together with the finger gap created therebetween, cooperate to form an improved grip for a handheld tool.

In another aspect, the control knob and the finger gap, with or without the handle, cooperate to form a control system for a handheld tool.

More generally, a maneuverability system for a handheld tool according to the present invention includes a handle means for holding the tool, a graspable lug means positioned on the shaft of the tool for directing the motion of the tool, and a hoist means positioned between the lug means and the handle means for further controlling the motion of the tool. The lug means has a graspable shape and size. The hoist means provides an additional place to engage the tool with the hand and move it. The lug means and the hoist means work together with the handle means to provide improved maneuverability of the tool.

More particularly describing one preferred embodiment, a handheld knife according to the invention comprises a control knob disposed upon the back edge of the knife blade and spaced apart from the handle to create a finger gap. The control knob has a rounded shape, a textured surface, and a size that is suitable for grasping by a thumb and/or one or more fingers of a hand. The finger gap is sized to allow the insertion of a thumb and/or one or more fingers. The control knob and the finger gap work together to provide improved maneuverability of the knife.

In one preferred method of the invention, the user may grasp the control knob with a thumb and/or one or more fingers and thereby direct the motion of the tool, while the other fingers and other parts of the hand cradle the tool handle.

In another preferred method of the invention, the user may grasp the tool shaft within the finger gap with a thumb and/or one or more fingers and thereby direct the motion of the tool, while the other fingers and other parts of the hand cradle the tool handle.

In yet another preferred method of the invention, the user may grasp the tool handle and extend a thumb and/or one or more fingers beyond the handle and grasp the control knob, while maintaining a grasp of the handle.

A method of fabricating a handheld tool, according to the present invention, includes the steps of providing a handle, connecting a shaft to the handle, disposing an implement or blade upon the shaft, and disposing a graspable knob on the shaft such that it is spaced apart from the handle, thereby creating a finger gap.

Thus, it is an object of the present invention to provide a method and apparatus for improving the maneuverability of a handheld tool such as a knife in all directions.

It is a further object of the present invention to provide a convenient and easily-grasped control device, separate from the handle, that will improve grip, control, safety, balance, and utility for handheld tools.

It is a further object of the present invention to provide an open area between such a control device and the handle, where the user may grasp the shaft or blade and thereby further improve grip, control, safety, balance, and utility of the knife or handheld tool.

These and other objects are accomplished by the apparatus, method, and system disclosed and will become apparent from the following detailed description of one preferred embodiment in conjunction with the accompanying drawings.

### BRIEF DESCRIPTION OF THE DRAWING

FIG. 1 is a pictorial view of a cleaving knife and how it might be held by a user, according to an embodiment of the present invention.

FIG. 2 is a diagrammatic top view of a cleaving knife according to an embodiment of the present invention.

FIG. 3 is a corresponding side view of the cleaving knife shown in FIG. 2.

FIG. 4 is a collection of top-view illustrations of the various sizes and shapes of control knobs and finger gaps according to embodiments of the present invention.

FIG. 5 is a collection of perspective-view illustrations corresponding to the views shown in FIG. 4.

FIG. 6 shows a variety of knives and control knobs according to embodiments of the present invention.

FIG. 7 shows a variety of control knobs of different shapes and sizes mounted on screwdrivers of various sizes, according to embodiments of the present invention.

FIG. 8 shows how a handheld screwdriver might be held by a user, according to an embodiment of the present invention.

FIG. 9 shows control knobs of different shapes and sizes mounted on handheld saws according to embodiments of the present invention.

FIG. 10 is a pictorial side view of a method of grasping the control knob according to an embodiment of the method of the present invention.

FIG. 11 is a pictorial side view of a method of exerting a lifting force on the control knob while grasping the handle of a knife, according to an embodiment of the method of the present invention.

FIG. 12 is a pictorial side view of a method of grasping the finger gap between the control knob and the handle of a knife, according to an embodiment of the method of the present invention.

FIG. 13 is a pictorial side view of a method of exerting a pushing force on the control knob while grasping the handle of a knife, according to an embodiment of the method of the present invention.

### DETAILED DESCRIPTION

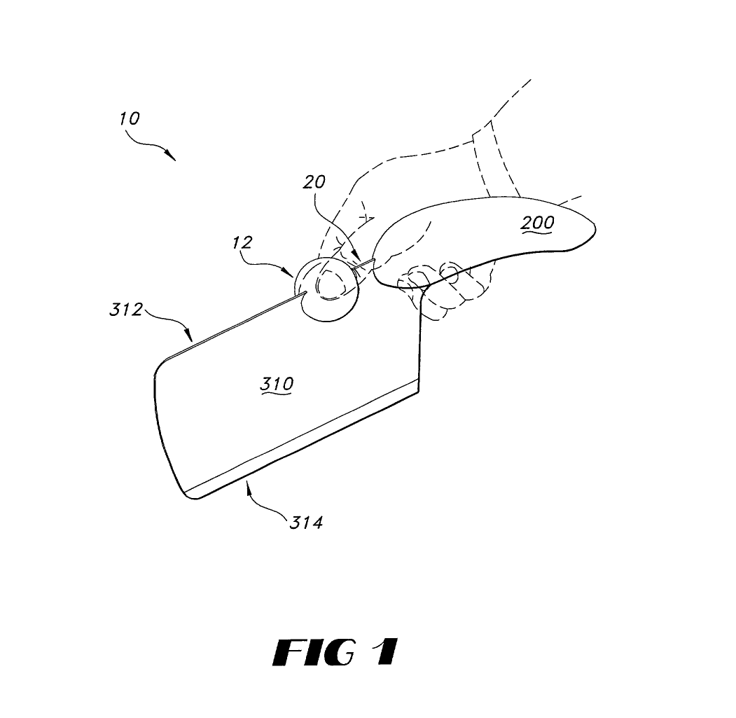

Reference is now made to the drawing figures, in which like numerals refer to like elements throughout the several views. FIG. 1 shows one embodiment of a handheld tool 10 according to the present invention. The tool 10 shown in FIG. 1 is a cleaving knife with a control knob 12 attached to a blade 310. It should be understood that a knife is a type of handheld tool 10. The control knob 12 is positioned along a back edge 312 of the blade 310. In one preferred embodiment, the control knob 12 is spaced apart from a handle 200, creating a finger gap 20 along the back edge 312.

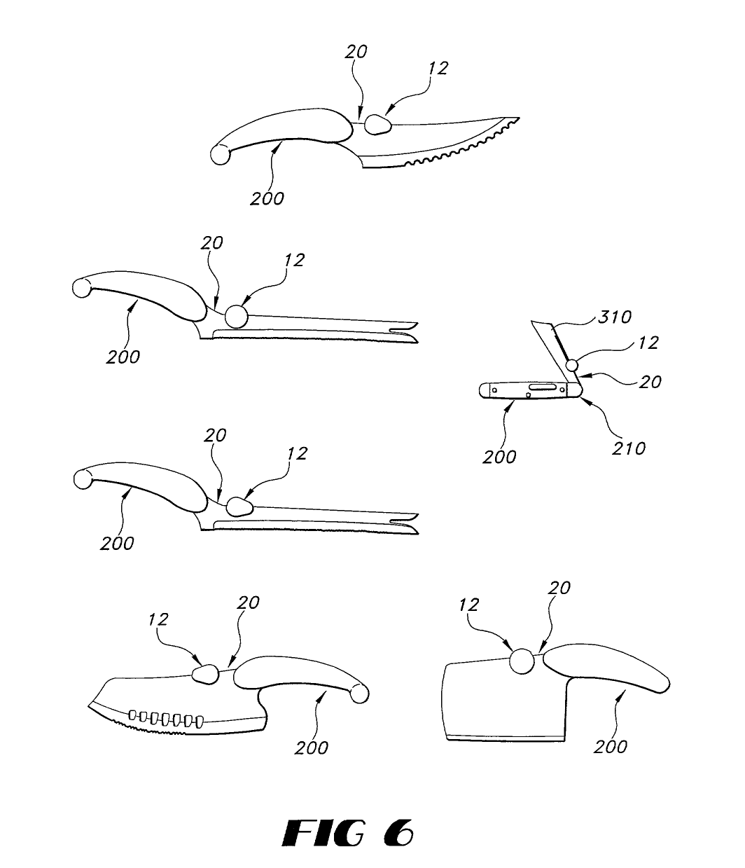

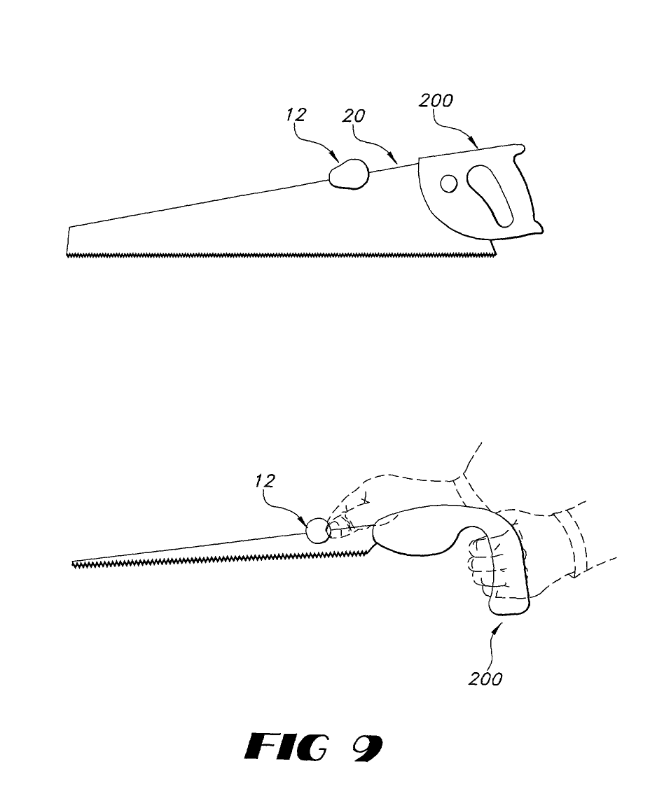

Although a cleaving knife is shown in FIG. 1, it should be understood that the present invention can be utilized with a variety of handheld tools 10 and with other types of knives as well. The control knob 12 may be well suited for all types of fixed-blade knives and for folding-blade knives such as the common pocket knife, as shown in FIG. 6. Uses with kitchen cutlery run the gamut from typical flatware to all kinds of utility and carving knives. The control knob 12 of the present invention can also provide advantages to other types of handheld tools 10, whether manually operated or power-driven, such as screwdrivers, saws, pliers, wrenches, axes, chisels, drills, files and rasps, hammers, clamps and vises, corkscrews, nutcrackers, forks, knives, spoons, ladles, tongs, chopsticks, probes, cookware handles, scoops, shears, and other handheld utensils. Several examples are shown in FIGS. 6 through 9, including methods involving both hands.

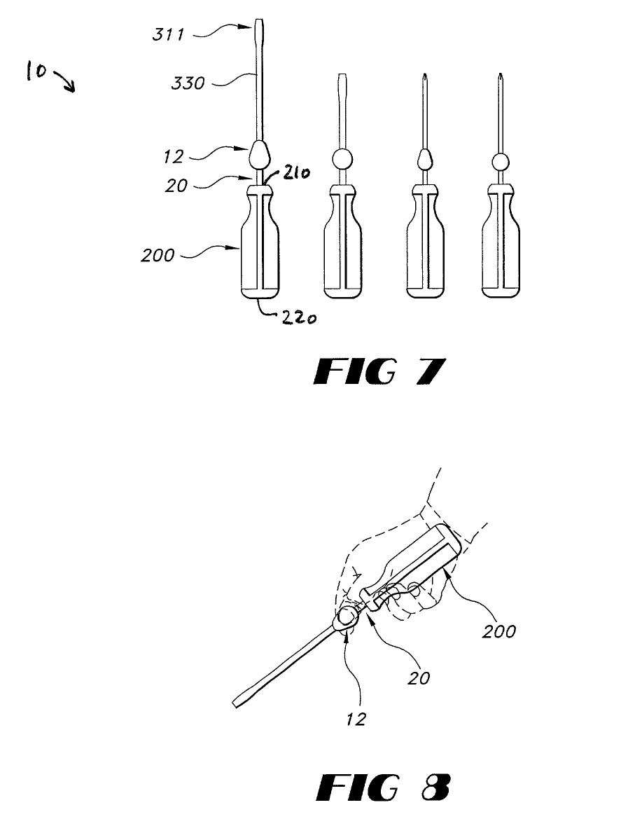

Referring briefly to FIG. 7, a handheld tool 10 generally comprises a handle 200 and a shaft 330. The handle 200 has a proximal end 220 and a distal end 210. The proximal end 220 is closer to the user. In general, the shaft 330 extends lengthwise from the distal end 210 of the handle 200 and includes an implement 311 disposed upon the shaft 330. The shaft 330 is generally elongate but may take any shape, depending upon the particular tool 10. The shaft 330 of a screwdriver, for example, may be cylindrical. Different handheld tools 10 use different implements 311. The implement 311 on the shaft 330 of a screwdriver, for example, may be a flathead bit.

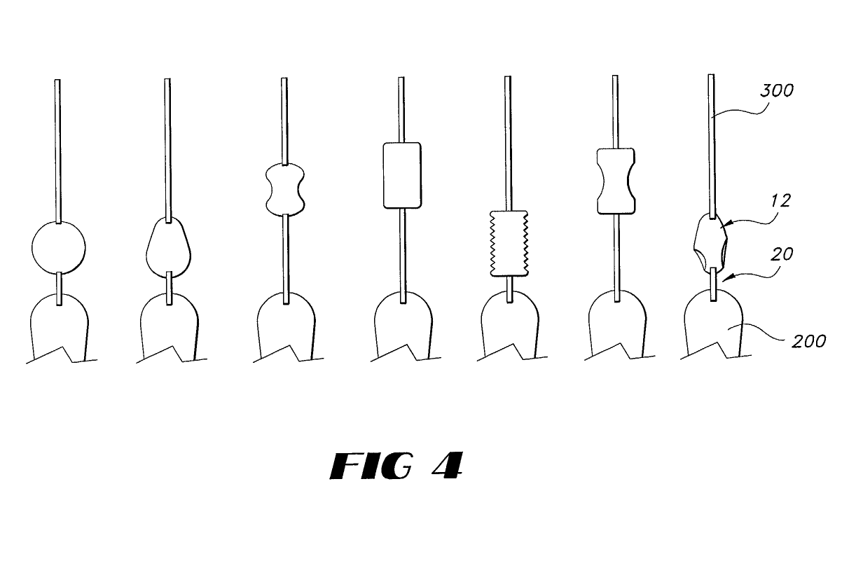

Referring to the handheld tool 10 in FIG. 3, a knife or saw generally comprises a handle 200 and a shank 300. The handle 200 has a pommel 220 and a hilt 210. When the knife 100 is held by a user, the pommel 220 is proximal to the user, while the hilt 210 is distal. Accordingly, the pommel 220 may be described as the proximal end of the handle 200 and the hilt as the distal end. As used herein, the hilt 210 describes the place where the forwardmost point of the handle 200 meets the blade 310.

The shank 300 of a knife or saw is elongate and generally planar, and has a blade 310 and a tang 320. The tang 320 extends into the handle 200 and is secured to the handle 200 by a conventional method. In general, the blade 310 extends lengthwise from said handle and has oppositely disposed lengthwise edges; specifically, a cutting edge 314 and an opposing back edge 312. The blade 310 may also include a tip or a leading edge 316, depending upon the shape of the blade 310.

The Control Knob

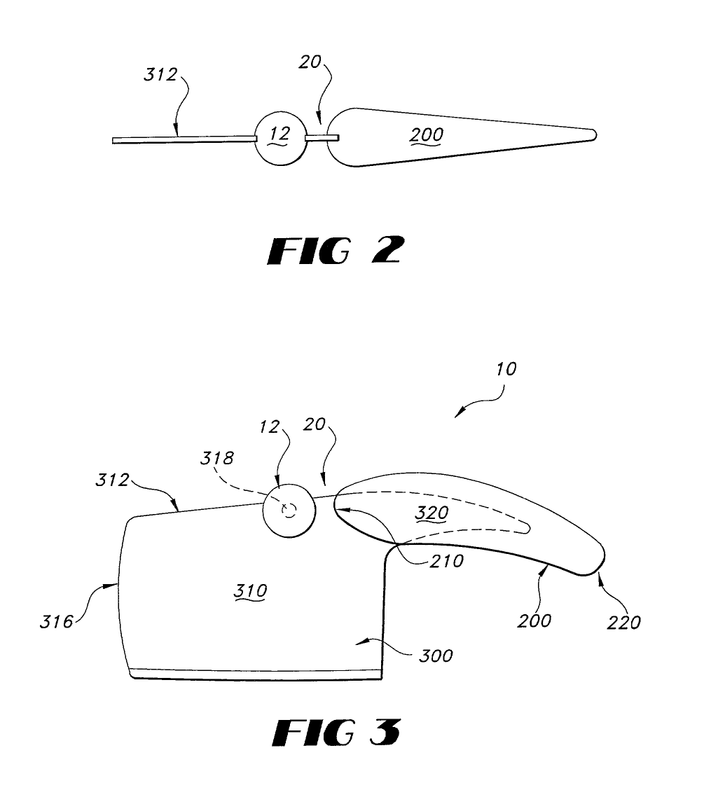

In one aspect of the invention, the control knob 12 is positioned on the shaft 330 of a handheld tool 10 such that it is spaced apart from the handle 200, thereby creating a finger gap 20. In one embodiment, shown in FIGS. 2 and 3, the control knob 12 may be positioned along the back edge 312 of a knife blade 310 such that it is spaced apart from the hilt 210 of the handle 200. The control knob 12 may be attached by molding it around the knife blade 310. More specifically, the control knob 12 may be molded around and through a hole 318 in the blade 310 to form a rigid and durable connection to the blade 310. Those skilled in the art will appreciate that other methods of attaching the control knob 12 to the blade 310 may be used, such as using a set screw.

In another embodiment of the present invention, the control knob 12 may be formed to include a narrow slot into which the shaft 330 or blade 310 could be inserted. As a means of attachment, a machine screw may be inserted and/or turned through the control knob 12 until it rests against the side of the blade 310 in a compression fit. Using a machine screw as a set screw would enable the location of the control knob 12 on the blade 310 to be adjusted according to the needs of the task and the user. In a related aspect, a control knob 12 with an adjustable position would necessarily create an adjustable finger gap 20. The finger gap 20 could be adjusted for any reason, such as to fit the particular size and/or number of digits to be inserted therein by a user or to accommodate the particular finger to be used in accomplishing a certain task or motion of the tool 10.

The location of the hole 318 in the blade 310, as shown in FIG. 3, is determined primarily by the durability and thickness of the blade 310. To maintain blade durability, the hole 318 needs to be far enough away from the back edge 312 so that the blade 310 is not weakened by the presence of the hole 318. The hole 318, however, also needs to be close enough to the back edge 312 so that the user may grasp the control knob 12 or, alternatively, reach into the finger gap 20. In this aspect of the invention, therefore, the position of the control knob 12 may be different for different types of knives or handheld tools 10. The location of the control knob 12 is governed in part by the need to create a usable finger gap 20 and the need to locate the hole 318 such that it will not weaken the blade 310 of the knife 100 or the shaft 330 of the tool 10.

The shape of the control knob 12 may be spherical or any other shape that is easily graspable. It should be noted that the concept of grasping, by definition, encompasses thumb and finger positions that are limited only by the maneuverability of the human hand. The hand itself, as discussed herein, includes a palm, four fingers, and an opposable thumb, any of which may be used alone or together for grasping an object. Moreover, any side of the palm, fingers, or thumb can be used to grasp an object. For example, in addition to the finger tip, the side or bottom of one phalanx may grasp an object by pressing against it. When a thumb or finger is described as grasping an object, the active portion of the digit in use should be understood to include the tip, the nail, the sides, the knuckles, the phalanges or individual bones, and any combination thereof.

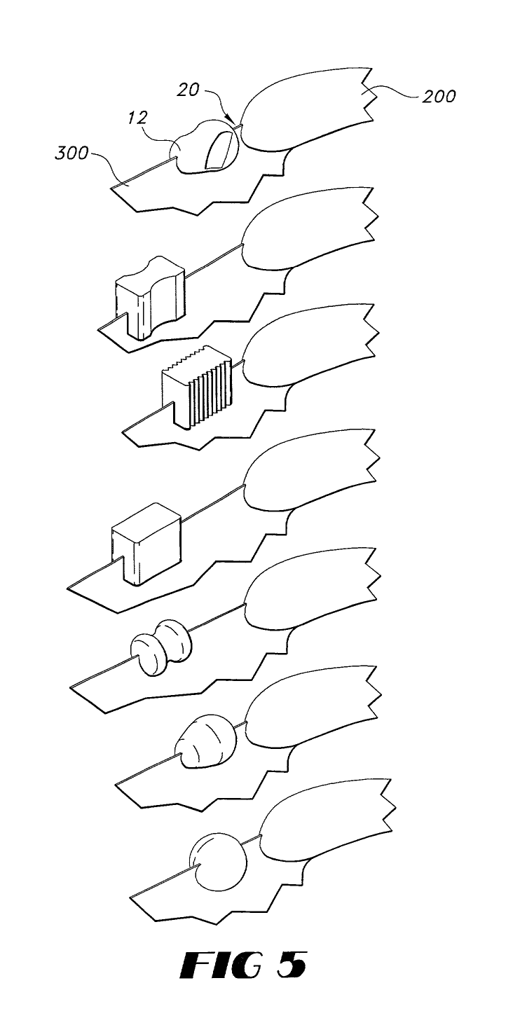

In one preferred embodiment, the control knob 12 is ovoid or egg-shaped. FIG. 2 is a top view of a knife having a generally spherical control knob 12. It should be understood that the control knob 12 of the present invention need not be symmetrical with respect to any plane of reference. The control knob 12 may take any shape that improves the maneuverability of the knife or handheld tool 10, including but not limited to a cube, a cylinder, an ellipsoid, a spool shape, an hourglass shape, or an amorphous non-geometrical shape designed to accept grasping by the fingers from a certain angle. It should be understood that the general term ellipsoid is used herein to describe a sphere, an egg shape, a rounded hourglass, or any other shape whose surface can be approximated by the rotation of circles or ellipses about any axis of rotation. Several examples are shown in FIGS. 4 and 5. Also, certain tools 10 may benefit from a control knob 12 that has a much different size or shape on one side of the shaft 330 or blade 310.

Similarly, it should be understood that the control knob 12 of the present invention need not be centered with respect to the plane of the shaft 330 or blade 310. Certain tools 10, for example, may benefit from a control knob 12 that is not centered with respect to the central plane of the shaft 330 or blade 310.

The surface of the control knob 12 may have a smooth or rough texture. Preferably, the control knob 12 has a non-slip texture for better gripping, particularly in wet environments. The control knob 12 may include distinct ridges at particular angles on the surface to facilitate grasping, or may include an omni-directional texture across the entire surface or any portion thereof.

In another aspect of the invention, the size of the control knob 12 is generally determined by the typical size and strength of the human hand. The diameter of a spherical control knob 12, for example, may be selected to create a sphere that is graspable by the thumb and index finger of a typical hand extending its reach forward from the handle 200. Depending upon the tool 10, the handle 200, the expected type of user, the density of the control knob 12, and other factors, the size of the control knob 12 may vary widely. In the case of a typical cleaving knife as depicted in FIGS. 1 through 3, the control knob 12 may have a diameter of about one inch (2.54 cm). In other applications, such as smaller screwdrivers, the control knob 12 may have a much smaller diameter. In a related aspect, the size of the control knob 12 is also governed in part by the desired size of the finger gap 20 to be created between the knob 12 and the handle 200.

The size of the control knob 12 is not limited by the size or shape of the shaft 330 or the blade 310. As shown in FIG. 1, the control knob 12 may be positioned atop the back edge 312 of a blade 310. In another embodiment, however, the control knob 12 may be seated such that its upper surface does not extend above the back edge 312. Moreover, when a control knob 12 of the present invention is attached to a slender shaft 330 of a handheld tool 10, such as a screwdriver, the control knob 12 may completely surround the shaft 330, as shown in FIG. 7.

The control knob 12 may be made of a variety of materials. In one preferred embodiment, the control knob 12 may be made of polyethylene, polystyrene, or any other material suitable for injection molding. Injection molding is one option among many for creating a rigid and durable connection between the control knob 12 and the shaft 330 or blade 310. Alternatively, the control knob 12 may be made of a soft, pliable material. Foam rubber, for example, may be used for applications where increased pinching of the control knob 12 has advantages. Furthermore, the control knob 12 of the present invention may comprise more than one material, such as a hard plastic core surrounded by a foam rubber outer layer.

In a related aspect of the invention, the material used for the control knob 12 may also vary depending upon the type of knife or handheld tool 10. For example, a softer, pliable, resilient rubber material might be used for a control knob 12 attached to the shaft 330 of a screwdriver.

In another aspect of the invention, the control knob 12 and the handle 200 may work together, with or without a usable finger gap 20, to complete an improved grip for a handheld tool 10.

In yet another aspect of the invention, a control knob 12 by itself may drastically improve graspability. For example, in the case of a utensil lacking a typical handle, such as a pair of tongs or chopsticks, a control knob 12 alone may provide an improved grip.

The Finger Gap

In another aspect of the invention, the control knob 12 is positioned on the shaft 330 or blade 310 such that it is spaced apart from the handle 200 to create a finger gap 20. The finger gap 20 lies between the hilt 210 of the handle 200 and the surface of the control knob 12. Generally, the finger gap 20 has a length sufficient to allow the insertion of one or more digits of a hand. In one preferred embodiment, the finger gap 20 has a length of approximately 0.25 inches (0.64 cm), although other widths may be useful for different knife shapes and different tools 10. In a related aspect to the invention, the length of the finger gap 20 may vary widely, depending upon the size and type of handheld tool 10 in use.

Some existing knife attachments include a small platform attached to the handle or bolster, for pushing the blade downward. In contrast to these platforms, the control knob 12 of the present invention is spaced apart from the handle 200. Moreover, the existence of the finger gap 20 between the control knob 12 and the handle 200 is an aspect of the present invention which increases the maneuverability of the tool 100 to a greater degree than would a simple pushing platform attached to the handle 200 itself.

In another aspect of the invention, the length of the finger gap 20 can be adjusted for particular uses when the position of the control knob 12 is adjustable. In one embodiment, the control knob 12 is secured by a set screw that can be loosened by the user in order to move the control knob 12 to a different location. In this way, the length of the finger gap 20 may be adjusted to fit a particular task or user.

In another aspect of the invention, the finger gap 20 and the control knob 12 may work together to provide a variety of improved control techniques that would not be otherwise available to the user. Improved control is provided in all linear and rotational directions. The number and variety of grasping positions are as numerous and varied as the shapes that can be made using the human hand.

Method of Fabrication

In another aspect of the present invention, a handheld tool 10 may be fabricated according to the present invention by providing a handle 200, connecting a shaft 330 to the handle 200, disposing an implement 311 upon the shaft 330, and disposing a control knob 12 upon the shaft such that the control knob 12 is spaced apart from the handle 200, creating a finger gap 20.

Methods for Using the Control Knob and the Finger Gap

In one aspect of the present invention, the control knob 12 and finger gap 20 may be used, with or without grasping the handle 200, in a variety of ways to control the position and motion of a handheld tool 10. In a related aspect, the control knob 12 and the finger gap 20 may work together in many situations to facilitate maneuverability of the tool 10 in all directions. Improved maneuverability means greater precision and control during both linear and rotational movements.

In a first method of the present invention, a user may grasp the control knob 12 with the thumb and one or more other fingers of the hand. When pinching the control knob 12, the user can manipulate the tool 10 in any direction, with or without grasping the handle 200. The fingers not grasping the control knob 12 may cradle or envelop the handle 200 if such a position is comfortable and does not interfere with overall balance or use of the tool 10. This grasping method is shown in FIG. 10. In one embodiment of the present invention, the control knob 12 may be located such that it improves the overall balance of the tool 10. By grasping the control knob 12 directly, the user is shortening the effective length of the tool 10 and, thereby, gaining better control.

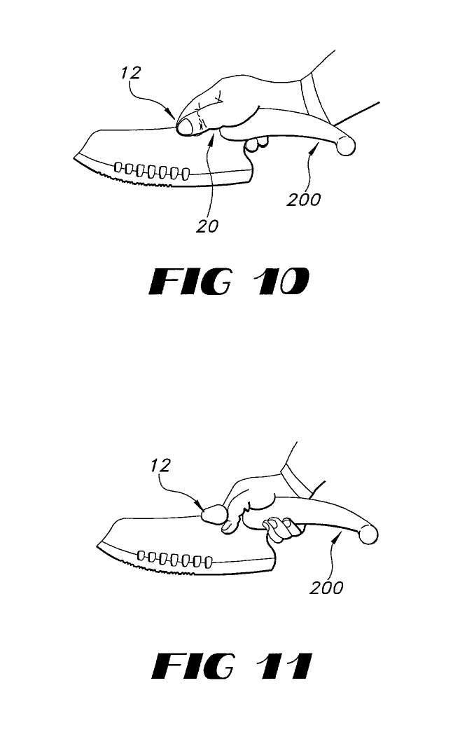

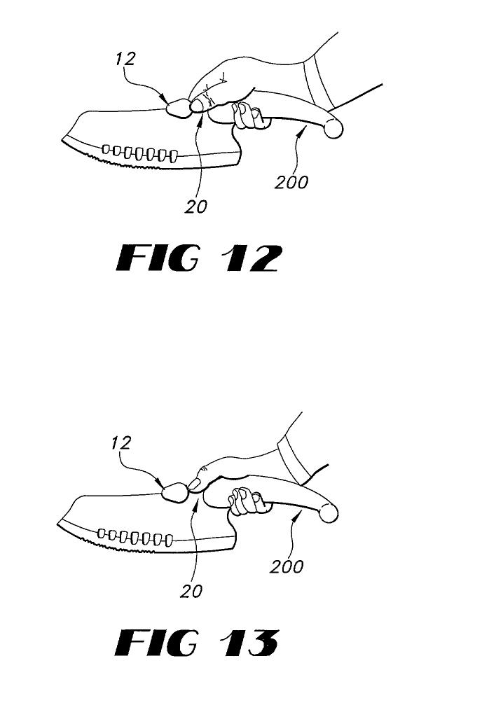

In a second method of the present invention, a user may grasp the finger gap 20 with the thumb and one or more other fingers of the hand, as shown in FIG. 12. When pinching the finger gap 20 along the shaft 330 of a handheld tool 10 or the back edge 312 of a knife blade 310, the user can manipulate the tool 10 in any direction, with or without grasping the handle 200. The fingers not grasping the control knob 12 may grasp the handle 200, as depicted in FIG. 12, or they may cradle or envelop the handle 200. An alternative grasping method is shown in FIG. 11, where the thumb or finger may be extended to a position somewhat beneath the control knob 12, thereby enabling the user to exert a lifting force on the tool 10. Similarly, as shown in FIG. 13, a user can place the thumb along the top of the finger gap 20 and grasp the handle 200 using a modified pistol grip, thereby gaining better control during forward and backward motion of the tool 10.

In a third method of the present invention, shown in FIG. 1, a user may hold the tool 10 in the ordinary manner, placing the palm generally on the top of the handle 200, and may extend the thumb and index finger forward to grasp the control knob 12. With two digits grasping the control knob 12 and the remaining digits and palm of the hand grasping the handle 200, the user may manipulate the tool 10 with greater control in all directions. In an alternative similar to that shown in FIG. 13, the user can place the thumb directly against the control knob 12 while grasping the handle 200 using a modified pistol grip, thereby also gaining better control during forward and backward motion of the tool 10.

In other methods of the present invention, the user may grasp all or part of the handle 200, the control knob 12, the finger gap 20, and any other part or parts of the tool 10, in any way that improves the maneuverability, precision, control, or grip. In this aspect, the various components of the present invention may work together, with the user, for better and safer control of any knife or handheld tool 10.

In another aspect of the various other methods of using the present invention, the thumb and fingers may be placed anywhere on or about the control knob 12, the finger gap 20, and/or adjacent areas of the handheld tool 10. In other words, the digits of either hand may grasp the control knob 12 and/or the finger gap 20 and/or any of the components of the tool 10, including the handle 200, the shank 300 or shaft 330, and the blade 310 or implement 311 itself.

When placed atop the control knob 12, the thumb and/or digits, or the opposite hand, may press downward on the control knob 12, increasing the downward force exerted by the implement 311, or the downward cutting force exerted by the blade 310. When placed beneath the control knob 12, the thumb and index finger may create a lifting force. Similarly, by placing digits fore and aft of the control knob 12, the user may gain control when pushing and pulling the tool 10.

Persons with disabilities may find that the present invention creates a significant advantage because of the increased graspability and safety provided. A person with a missing or weakened digit that is typically needed to control a handheld tool 10, for example, may find that the existence of the finger gap 20 and the control knob 12 provide an extra degree of maneuverability. Likewise, children and the elderly who may have decreased grip strength and other motor skills deficits may find a distinct advantage when a tool 10 includes the present invention. Similarly, the addition of a control knob 12 of the present invention on eating utensils, chopsticks, can openers, scissors, and other handheld tools 10 will increase graspability and control for users of all levels of ability and skill.

In another aspect of the present invention, the control knob 12 may improve the overall balance of the tool 10. Because the control knob 12 is positioned beyond the hilt 210 of the handle 200, the user changes the effective length of the tool 10, in effect, when grasping the control knob 12. Persons skilled in the art will understand that an additional level of control is gained when a tool 10 is effectively shortened. In fact, it may be observed that use of the control knob 12 of the present invention actually promotes proper cutting technique, for example, and thereby increases the safety of the use of any knife or handheld tool 10.

For example, during slicing or chopping tasks, grasping the control knob 12 will create a different pivot point or fulcrum about which the entire knife 10 may rotate, for greater control during any cutting activity. Additionally, the presence of the control knob 12 allows the user to more firmly grasp the back edge 312 of the knife blade and control the slicing or chopping motion of the blade 310. The effective length of the knife 10 with respect to the new fulcrum created by the improved hand position not only promotes proper cutting technique, but also increases the force and efficiency with which the cutting is accomplished.

In another aspect of the invention, the location of the control knob 12 not only provides greater leverage for the user, but may also provide increased visibility of the workpiece. The shorter effective length created by grasping the control knob 12 also shortens the distance between the user and the workpiece, thereby generally making the workpiece closer and more visible. Moreover, the act of controlling the knife or tool 10 by grasping the control knob 12 may naturally draw the user's attention toward the workpiece.

The Control System

In another aspect, the control knob 12 of the present invention creates an improved control system for a handheld tool 10. The system implicitly includes a finger gap 20, created by the position of the control knob 12 on the shaft 330 or blade 310. The elements created by the addition of the control knob 12 of the present invention cooperate to provide an improved overall control system for a knife or other handheld tool 10.

More generally, such a control system for improved maneuverability may include any handle means for holding a handheld tool 10 with one or more hands. Handle means may include an elongate grip or handle, with or without ridges to accept the fingers, of a type generally known in the art. Handle means may be specially shaped or curved to conform to and accept the hand and fingers. A handle means functions to accept the fingers and palm, generally, of the hand controlling a handheld tool 10. Those skilled in the culinary arts will appreciate the variety of handle means available which are well-suited for the present invention.

Such a maneuverability system may also include a lug means for directing a handheld tool 10 in a desired way. Lug means may include a control knob disposed upon the shaft 330 or blade 310 that is sized and shaped to be easily grasped by one or more digits of the hand. A lug means functions as an attachment to the shaft 330 or blade 310 to enable the user to move the tool 10 in any direction. Accordingly, the lug means must be capable of receiving forces in all directions and transmitting them to the tool 10 to result in controlled motion as desired by the user.

In another aspect of such a maneuverability system, the lug means may be generally disposed upon the shaft 330 or blade 310 of a handheld tool 10 at a location that creates a hoist means for directing the implement 311 of the tool 10. A hoist means functions as a location on the shaft 330 or blade 310 that, in addition to the lug means, enables the user to move the tool 10 in any direction. The hoist means may include a finger gap 20 between the lug means and the handle 200 of the tool 10. The hoist means may include a gap, a protrusion, or another change in shape of one or more of the components of the tool 10 itself, so as to create a place to engage the tool 10 with the hand and move it. Like the lug means, the hoist means must be capable of receiving forces in all directions and transmitting them to the tool 10 to result in controlled motion as desired by the user.

Although the invention has been described in terms of a preferred embodiment, it will be appreciated by those skilled in the art that additions, substitutions, modifications, and deletions not specifically described may be made without departing from the spirit and scope of the invention.

What is claimed is:

1. A handheld tool, comprising:
a handle having opposing proximal and distal ends;
a shaft connected to said handle and extending lengthwise from said distal end;
an implement disposed upon said shaft;
a control knob disposed upon said shaft and spaced apart from said distal end, thereby defining a finger gap.

2. The handheld tool of claim 1, wherein said finger gap is of sufficient length to receive one or more digits of a hand.

3. The handheld tool of claim 1, wherein the position of said control knob upon said shaft is adjustable.

4. The handheld tool of claim 1, wherein said control knob and said finger gap cooperate to provide improved maneuverability of said tool.

5. The handheld tool of claim 1, wherein said control knob is sized and shaped to be graspable by one or more digits of a hand.

6. The handheld tool of claim 1, wherein said control knob is ovoid in shape.

7. The handheld tool of claim 1, wherein said control knob has a shape selected from the group consisting of ovoid, spherical, ellipsoidal, cylindrical, cubical, prismatic, spool-shaped, and amorphous.

8. The handheld tool of claim 1, wherein said control knob has a textured surface.

9. The handheld tool of claim 1, wherein said control knob is pliable.

10. The handheld tool of claim 1, wherein said tool is a knife,
said shaft comprising a shank having opposing tang and blade ends, said tang end connected to said handle and said blade end extending lengthwise from said distal end,
said implement comprising a blade having oppositely disposed cutting and back edges, and
said control knob being disposed upon said back edge of said blade and spaced apart from said distal end, thereby defining a finger gap.

11. A grip for a handheld tool, the tool characterized by a shaft and an implement disposed upon said shaft, said grip comprising:
a handle having opposing proximal and distal ends, said shaft connected to said handle and extending lengthwise from said distal end; and
a control knob disposed upon said shaft and spaced apart from said distal end, thereby defining a finger gap.

12. The grip of claim 11, wherein said finger gap is of sufficient length to receive one or more digits of a hand.

13. The grip of claim 11, wherein the position of said control knob upon said shaft is adjustable.

14. The grip of claim 11, wherein said control knob and said finger gap cooperate to provide improved maneuverability of said tool.

15. The grip of claim 11, wherein said control knob is sized and shaped to be graspable by one or more digits of a hand.

16. The grip of claim 11, wherein said control knob is ovoid in shape.

17. The grip of claim 11, wherein said control knob has a shape selected from the group consisting of ovoid, spherical, ellipsoidal, cylindrical, cubical, prismatic, spool-shaped, and amorphous.

18. The grip of claim 11, wherein said control knob has a textured surface.

19. The grip of claim 11, wherein said control knob is pliable.

20. The grip of claim 11, wherein said tool is a knife,
said shaft comprising a shank having opposing tang and blade ends, said tang end connected to said handle and said blade end extending lengthwise from said distal end,
said implement comprising a blade having oppositely disposed cutting and back edges, and
said control knob being disposed upon said back edge of said blade and spaced apart from said distal end, thereby defining a finger gap.

21. A control knob for a handheld tool, the tool characterized by a handle having opposing proximal and distal ends, a shaft connected to said handle and extending lengthwise from said distal end, and an implement disposed upon said shaft, said control knob comprising:
a knob sized and shaped to be graspable by one or more digits of a hand,
said knob disposed upon said shaft and spaced apart from said distal end, thereby defining a finger gap.

22. A method of maneuvering a handheld tool, the tool characterized by a handle having opposing proximal and distal ends, a shaft connected to said handle and extending lengthwise from said distal end, and an implement disposed upon said shaft, said method comprising:
disposing a control knob upon said shaft such that said control knob is spaced apart from said distal end, thereby defining a finger gap;
grasping said tool with a hand; and
pressing said hand in any direction.

23. The method of claim 22, wherein said step of grasping said tool comprises grasping said control knob with one or more digits of said hand.

24. The method of claim 22, wherein said step of grasping said tool comprises grasping said shaft within said finger gap with one or more digits of said hand.

25. The method of claim 22, wherein said step of grasping said tool comprises:
grasping said handle with said hand;
extending one or more digits of said hand beyond said distal end of said handle; and
grasping said control knob.

26. The method of claim 22, wherein said step of grasping said tool comprises:
grasping said handle with said hand;
extending one or more digits of said hand beyond said distal end of said handle; and
grasping said shaft within said finger gap.

27. A method of fabricating a handheld tool, comprising:
providing a handheld tool comprising a handle having opposing proximal and distal ends, a shaft connected to said handle and extending lengthwise from said distal end, and an implement disposed upon said shaft; and
disposing a graspable knob upon said shaft such that said knob is spaced apart from said distal end, thereby defining a finger gap.

28. The method of claim 27, wherein said tool is a knife,
said shaft comprising a shank having opposing tang and blade ends, said tang end connected to said handle and said blade end extending lengthwise from said distal end,
said implement comprising a blade having oppositely disposed cutting and back edges, and
wherein said step of disposing a graspable knob upon said shaft comprises the step of disposing said graspable knob upon said back edge of said blade and spaced apart from said distal end, thereby defining a finger gap.

29. The method of claim 27, wherein said step of disposing said graspable knob is performed such that said finger gap is of sufficient length to receive one or more digits of a hand.

30. The method claim 27, wherein said step of disposing a graspable knob upon said shaft is performed such that the position of said control knob is adjustable.

31. The method of claim 27, wherein said step of disposing said graspable knob is performed such that said graspable knob and said finger gap cooperate to provide improved maneuverability of said tool.

32. A maneuverability system for a handheld tool, the tool characterized by a shaft and an implement disposed upon said shaft, said system comprising:
a handle means for holding said tool with a hand, said handle means having opposing proximal and distal ends, said shaft connected to said handle means and extending lengthwise from said distal end; and
a lug means for directing said implement, said lug means sized and shaped to be graspable by one or more digits of said hand,
said lug means disposed upon said shaft and spaced apart from said distal end, thereby defining a hoist means for directing said implement, said hoist means including a gap sized and shaped to receive one or more digits of said hand.

33. The maneuverability system of claim 32, wherein the position of said lug means upon said shaft is adjustable.

34. The maneuverability system of claim 32, wherein said hoist means and said lug means cooperate to provide improved maneuverability of said tool.

35. The maneuverability system of claim 32, wherein said tool is a knife,
said shaft comprising a shank having opposing tang and blade ends, said tang end connected to said handle means and said blade end extending lengthwise from said distal end,
said implement comprising a blade having oppositely disposed cutting and back edges, and
said lug means being disposed upon said back edge of said blade and spaced apart from said distal end, thereby defining a hoist means.

36. The maneuverability system of claim 32, wherein said lug means is sized and shaped to be graspable by one or more digits of a hand.

37. The maneuverability system of claim 32, wherein said lug means is ovoid in shape.

38. The maneuverability system of claim 32, wherein said lug means has a shape selected from the group consisting of ovoid, spherical, ellipsoidal, cylindrical, cubical, prismatic, spool-shaped, and amorphous.

39. The maneuverability system of claim 32, wherein said lug means has a textured surface.

40. The maneuverability system of claim 32, wherein said lug means is pliable.

41. A handheld knife, comprising:
a handle having opposing proximal and distal ends;
a shank having opposite tang and blade ends, said tang end connected to said handle and said blade end extending lengthwise from said distal end, said blade end having oppositely disposed cutting and back edges,
a control knob disposed upon said back edge and spaced apart from said distal end, thereby defining a finger gap.

42. The handheld knife of claim 41, wherein said finger gap is of sufficient length to receive one or more digits of a hand.

43. The handheld knife tool of claim 41, wherein the position of said control knob upon said back edge is adjustable.

44. The handheld knife of claim 41, wherein said control knob and said finger gap cooperate to provide improved maneuverability of said knife.

45. The handheld knife of claim 41, wherein said control knob is ellipsoid in shape, has a textured surface, and is sized to be graspable by one or more digits of a hand.

46. The handheld knife of claim 41, wherein said control knob is pliable.
